(19) United States
(12) Patent Application Publication
(10) Pub. No.: US 2026/0071059 A1
(43) Pub. Date: Mar. 12, 2026

(54) RUBBER COMPOSITION AND PNEUMATIC TIRE

(71) Applicant: Toyo Tire Corporation, Itami-shi (JP)

(72) Inventor: Yosuke Nakaji, Itami-shi (JP)

(73) Assignee: Toyo Tire Corporation, Itami-shi (JP)

(21) Appl. No.: 19/307,333

(22) Filed: Aug. 22, 2025

(30) Foreign Application Priority Data
Sep. 10, 2024 (JP) 2024-155425

(51) Int. Cl. C08L 9/06; B60C 1/00; C08K 3/36; C08K 5/103

(52) U.S. Cl. CPC C08L 9/06; B60C 1/00; C08K 3/36; C08K 5/103; C08L 2205/025

(57) ABSTRACT

A rubber composition comprising a diene-based rubber and a dehydrated castor oil, wherein the content of the dehydrated castor oil is 15 to 40 parts by mass when the total amount of the diene-based rubber is 100 parts by mass. It is preferred that the rubber composition further comprises silica.

### FIELD OF THE INVENTION

The present invention relates to a rubber composition and a pneumatic tire.

### Description of the Related Art

Conventionally, it has been common to incorporate aroma oil (mineral oil) as a plasticizer into a rubber composition for a pneumatic tire. However, in recent years, there has been an increasing demand for replacing aroma oil, which is a petroleum-derived resource, toward a social construction conscious of SDGs, and it is desired to use an oil derived from a plant when a pneumatic tire is manufactured.

Patent Document 1 below describes a rubber composition for a sidewall or a base tread comprising a rubber component containing 2 or more diene-based rubbers and a glycerol fatty acid triester derived from a petroleum external resource, wherein the rubber component contains at least 1 diene-based rubbers selected from the group consisting of natural rubber, epoxidized natural rubber, and butadiene rubber, and the glycerol fatty acid triester has a content of 45% by mass or more of oleic acid, and a total content of natural rubber and butadiene rubber in 100% by mass of the rubber component is 50% by mass or more, or a total content of natural rubber and epoxidized natural rubber in 100% by mass of the rubber component is 50% by mass or more.

In addition, Patent Document 2 below describes a rubber composition comprising at least a diene elastomer, a reinforcing filler between a 60 phr and a 120 phr, a plasticizer, which comprises more than 10 phr and less than 80 phr vegetable oils, between a 40 phr and a 100 phr and a microparticle of a water-soluble sulfate selected from the group consisting of a magnesium sulfate between a 2 phr and a 40 phr, a potassium sulfate and mixtures thereof.

Also, in Patent Document 3 below, rubber compositions are described which are characterized in that they comprise, based on parts by weight per elastomer (phr) of 100 parts by weight,
(A) at least one conjugated diene elastomer,
(B) 5 to 60 phr of triglyceride ester-based specialized soybean oil, as well as
(C) reinforcing fillers of 30 to 140 phr.

Further, Patent Document 4 below describes a rubber composition for a tire tread, which is obtained by blending, with respect to 100 parts by weight of a natural rubber and/or a diene-based synthetic rubber, 40 to 100 parts by weight of carbon black having a 90 to 220 m²/g cetyltriammonium bromide adsorption specific surface area (CTAB) and a 90 to 140 ml/100 g property value of 24M4DBP oil absorption, and 0.1 to 20 parts by weight of an organic unsaturated fatty acid containing 2 or more carbon-carbon double bonds in a molecule containing 10% by weight or more of a conjugated dienic acid containing at least one set of 2 carbon-carbon double bonds in a molecule in a conjugated relation.

### PRIOR ART DOCUMENT

### Patent Document

Patent Document 1: JP-B-5679798
Patent Document 2: JP-B-6689273
Patent Document 3: JP-B-7104509
Patent Document 4: JP-B-3200067

### SUMMARY OF THE INVENTION

In the technique described in Patent Document 1 described above, sunflower oil and safflower oil are used as non-aroma oils. In addition, in the technique described in Patent Document 2 described above, soybean oil, sunflower oil and safflower oil are used as non-aroma oils. In addition, in the technique described in Patent Document 3 described above, soybean oil is used as a non-aroma oil. However, vulcanized rubber of the rubber composition described in these patent documents do not improve rubber physical properties, such as breaking strength and tear force, especially when used for pneumatic tire applications.

Incidentally, in the technique described in Patent Document 4 described above, a rubber composition is used in which a dehydrated castor oil fatty acid having a carboxyl group and not having a triglyceride skeleton is blended as an organic unsaturated fatty acid, particularly in order to improve abrasion resistance, when used in a pneumatic tire application.

In view of the above circumstances, it is an object of the present invention to provide a rubber composition using an oil derived from a plant, which becomes a raw material of a vulcanized rubber excellent in rubber physical properties such as breaking strength and tear force when used in a pneumatic tire application.

The above object can be achieved by the present invention as described below. Specifically, the present invention relates to a rubber composition (1) containing a diene-based rubber and a dehydrated castor oil, wherein the content of the dehydrated castor oil is 15 to 40 parts by mass when the total amount of the diene-based rubber is 100 parts by mass.

The rubber composition (1) is preferably a rubber composition (2) further containing silica.

The present invention also relates to a pneumatic tire containing a vulcanized rubber of the rubber composition (1) or (2).

The rubber composition according to the present invention contains dehydrated castor oil as an oil derived from a plant. The dehydrated castor oil contains, as a main component, triglycerides in which ricinoleic acid which are fatty acids and glycerin are ester-linked. In other words, the dehydrated castor oil fatty acid having a carboxyl group and not having triglyceride skeleton and the dehydrated castor oil are completely different from each other, and as far as the present inventor is aware, there is no example of a case in which a dehydrated castor oil is blended in a rubber composition used particularly for a pneumatic tire application.

In the dehydrated castor oil, the unsaturated bond in the skeleton increases due to the dehydration reaction of the hydroxyl group provided in the fatty acid. By this increase in the unsaturated bond and the triglyceride skeleton contained in the molecule, the affinity between the dehydrated castor oil and the diene rubber is increased, and as a result, the vulcanized rubber of the rubber composition has improved rubber physical properties such as breaking strength and tear force.

### DETAILED DESCRIPTION OF THE PREFERRED EMBODIMENTS

The rubber composition according to the present invention contains diene-based rubber and a dehydrated castor oil.

Examples of the diene-based rubber include styrene butadiene rubber such as emulsion-polymerized polystyrene butadiene rubber (hereinafter, also referred to as “E-SBR”) and solution-polymerized polystyrene butadiene rubber (hereinafter, also referred to as “S-SBR”) obtained by an emulsion polymerization method (radical polymerization method) in water, natural rubber, isoprene rubber, and butadiene rubber.

The dehydrated castor oil contains triglycerides in which ricinoleic acid which are fatty acids and glycerin are ester-linked, as a main component. In the rubber composition according to the present invention, when the total amount of the diene-based rubber is 100 parts by mass, the content of the dehydrated castor oil is set to 15 to 40 parts by mass. When the content of the dehydrated castor oil is less than 15 parts by mass when the total amount of the diene-based rubber is 100 parts by mass in the rubber composition, the tearing force tends to be deteriorated when the rubber is vulcanized, and when the content of the dehydrated castor oil exceeds 40 parts by mass, the breaking strength and the tearing force tend to be deteriorated when the rubber is vulcanized.

Although the rubber composition according to the present invention may contain an aroma oil as a plasticizer, it is preferable that the blending amount is as small as possible from the viewpoint of SDGs, and specifically, when the total amount of the diene-based rubber is 100 parts by mass, the blending amount of the aroma oil is preferably 50 parts by mass or less, more preferably 40 parts by mass or less, and particularly preferably no aroma oil is contained.

The rubber composition according to the present invention preferably contains, along with dehydrated castor oil, silica as a filler. Examples of the silica to be used include silicas usually used for rubber reinforcement, such as wet silica, dry silica, sol-gel silica, and surface-treated silica. Among these, wet silica is preferred. The content of the silica is preferably 1 to 150 parts by mass of the rubber component in the rubber composition.

When silica is contained as a filler, a silane coupling agent is also preferably contained together. The silane coupling agent is not limited as long as sulfur is contained in the molecule thereof, and various silane coupling agents to be added to rubber compositions together with silica may be used. Examples of such silane coupling agents include: sulfidesilanes such as bis(3-triethoxysilylpropyl) tetrasulfide (e.g., “Si69” manufactured by Degussa), bis(3-triethoxysilylpropyl) disulfide (e.g., “Si75” manufactured by Degussa), bis(2-triethoxysilylethyl)tetrasulfide, bis(4-triethoxysilylbutyl)disulfide, bis(3-trimethoxysilylpropyl) tetrasulfide, and bis(2-trimethoxysilylethyl)disulfide; mercaptosilanes such as γ-mercaptopropyltrimethoxysilane, γ-mercaptopropyltriethoxysilane, mercaptopropylmethyldimethoxysilane, mercaptopropyldimethylmethoxysilane, and mercaptoethyltriethoxysilane; and protected mercaptosilanes such as 3-octanoylthio-1-propyltriethoxysilane and 3-propionylthiopropyltrimethoxysilane. In the rubber composition, when the total amount of silica is set to 100% by mass, the content of the silane coupling agent is preferably 1 to 20% by mass.

The rubber composition according to the present invention may contain, as a filler, carbon black. Examples of the carbon black that can be used include: carbon blacks usually used in the rubber industry, such as SAF, ISAF, HAF, FEF, and GPF; and conductive carbon blacks such as acetylene black and ketjen black. The content of carbon black to be blended in the rubber composition preferably 1 to 60 parts by mass of the diene-based rubber in the rubber composition.

The rubber composition according to the present invention may contain, in addition to the diene-basd rubber, dehydrated castor oil, silica and further carbon black, silane coupling agent, vulcanizing agent, a vulcanization accelerator, an antiaging agent, stearic acid, a softener such as wax or oil, a processing aid, etc.

As the antiaging agent, antiaging agents usually used for rubber, such as an aromatic amine-based antiaging agent, an amine-ketone-based antiaging agent, a monophenol-based antiaging agent, a bisphenol-based antiaging agent, a polyphenol-based antiaging agent, a dithiocarbamic acid salt-based antiaging agent, and a thiourea-based antiaging agent can be used. These may be used singly or in an appropriate combination. The content of the antiaging agent to be blended in the rubber composition preferably 1 to 5 parts by mass of the diene-based rubber in the rubber composition.

Examples of the vulcanization-based compounding agent include a vulcanizing agent such as sulfur and an organic peroxide, a vulcanization accelerator, a vulcanization accelerating aid, and a vulcanization retarder.

Sulfur as a vulcanizing blend may be conventional rubber sulfur. For example, powdered sulfur, precipitated sulfur, insoluble sulfur, or highly dispersible sulfur can be used. When the rubber physical properties and durability after vulcanization are taken into consideration, the amount of sulfur blended is preferably from 0.1 to 5 parts by mass, more preferably from 0.5 to 3.5 parts by mass, in terms of sulfur content, when the total amount of the diene-based rubber is taken as 100 parts by mass.

Examples of the vulcanization accelerator include vulcanization accelerators usually used for rubber vulcanization, such as a sulfenamide-based vulcanization accelerator, a thiuram-based vulcanization accelerator, a thiazole-based vulcanization accelerator, a thiourea-based vulcanization accelerator, a guanidine-based vulcanization accelerator, and a dithiocarbamic acid salt-based vulcanization accelerator, and these may be used singly or in an appropriate combination. The amount of vulcanization accelerator is preferably from 0.5 to 6 parts by mass when the total amount of the diene-based rubber is taken as 100 parts by mass.

The rubber composition according to the present invention is obtained by kneading the diene-based rubber, the dehydrated castor oil, silica and further carbon black, silane coupling agent, the vulcanizing agent, the vulcanization accelerator, the antiaging agent, stearic acid, the softener such as wax or oil, the processing aid, etc. with the use of a kneading machine usually used in the rubber industry, such as a Banbury mixer, a kneader, or a roll.

A method for blending the above components is not limited, and any one of the following methods may be used: a method in which components to be blended other than vulcanization-type compounding agents such as a vulcanizing agent and a vulcanization accelerator are previously kneaded to prepare a master batch, the remaining components are added to the master batch, and the resultant is further kneaded, a method in which components are added in any order and kneaded, and a method in which all the components are added at the same time and kneaded.

Since the rubber composition according to the present invention uses dehydrated castor oil which is an oil derived from a plant, it is environmentally friendly. Therefore, it is particularly suitable as a rubber composition for use in a pneumatic tire application in which a demand for replacing aroma oil, which is a petroleum-derived resource, has been particularly increased in recent years toward social construction conscious of SDGs. In addition, since the vulcanized rubber of the rubber composition according to the present invention is excellent in rubber physical properties such as breaking strength and tear force, a pneumatic tire comprising a vulcanized rubber of a rubber composition according to the present invention has improved tire performance such as durability.

### EXAMPLES

Hereinbelow, the configuration and effect of the present invention will be described with reference to specific examples etc. Incidentally, evaluation items in Examples and the like, each rubber composition was heated at 160° C. for 20 minutes, the rubber sample obtained by vulcanization was evaluated based on the following evaluation conditions.

### (Breaking Strength of Vulcanized Rubber of Rubber Composition)

The breaking strength was measured in a tensile test according to JIS K6251 (JIS3 No. dumbbell), and the value of Comparative Example 1 was expressed as an index taken as 100. The larger the value, the better the breaking strength of vulcanized rubber.

### (Tearing Force of Vulcanized Rubber of Rubber Composition)

The vulcanized rubbers obtained above were punched in a JIS K6252 defined crescent form to yield a sample with a 0.50±0.08 mm cut in the center of the indentation. Tear strength was measured at the tensile rate of 500 mm/min by a tensile tester at Shimazu, and the index was expressed as 100 for the comparative case 1. The larger the numerical value, the better the tearing force of the vulcanized rubber.

### (Preparation of Rubber Composition)

According to the formulation of Table 1, the rubber compositions of Example 1-3 and Comparative Example 1-3 were blended and kneaded using an ordinary Banbury mixer to adjust the rubber composition. Each of the blending agents described in the table is shown below (in Table 1, the blending amount of each blending agent is shown in parts by mass based on 100 parts by mass of the rubber component)
SBR1 (ESBR (emulsion-polymerization SBR): trade name
SBR1502 (manufactured by ENEOS Material)
SBR2 (SSBR (solution-polymerization SBR): trade name “HPR350” (manufactured by ENEOS Material Co., Ltd.)
Carbon black (CB) (HAF): trade name “N339 Seast KH” (manufactured by Tokai Carbon Co., Ltd.)
Silica: trade name “Nipshire AQ” (Tosoh Co.,)
Silane coupling agent: trade name Si69 (Degusa Co., Ltd.)
Vegetable Oil 1 (Soybean Oil): trade name Soybean Oil (Fujifilm Wako Pure Pharmaceutical Co., Ltd.)
Dehydrated castor oil: DCO (Ito Oil Co., Ltd.)
Stearic Acid: trade name Lunac S-20 (Kao Co., Ltd.)
Zinc Oxide: trade name Zinc Oxide 2 (Mitsui Metal Mineral Co., Ltd.)
Wax: trade name “OZOACE0355” (manufactured by Nippon Seiyu Co., Ltd.)
Anti-aging agent 1: trade name “Nocrac 6C” (manufactured by Dainippon Shinko Chemical Industry Co., Ltd.)
Anti-aging agent 2: trade name “ANTAGE RD” (Kawaguchi Chemical Co., Ltd.)
Vulcanization accelerator 1: trade name “Soxinol CZ” (manufactured by Sumitomo Chemical Co., Ltd.)
Vulcanization accelerator 2: trade name “NOXERA D” (made by Ouchi New Chemicals)
Sulfur: trade name “Powdered Sulfur” (Tsurumi Chemical Co., Ltd.)

TABLE 1

| Comparative | Comparative | Comparative | | | |
|---|---|---|---|---|---|
| Example | Example | Example | Example | Example | Example |
| 1 | 2 | 3 | 1 | 2 | 3 |

(Formulation)

| | | | | | | |
|---|---|---|---|---|---|---|
| SBR1 | 40 | 40 | 40 | 40 | 40 | 40 |
| SBR2 | 60 | 60 | 60 | 60 | 60 | 60 |
| Carbon black | 5 | 5 | 5 | 5 | 5 | 5 |
| Silica | 85 | 85 | 85 | 85 | 85 | 85 |
| Silane coupling | 7 | 7 | 7 | 7 | 7 | 7 |
| agent | | | | | | |
| Vegetable Oil 1 | 36 | | | | | |
| Dehydrated | | 13.5 | 40.5 | 16.2 | 27 | 35.1 |
| castor oil | | | | | | |
| Stearic Acid | 2 | 2 | 2 | 2 | 2 | 2 |
| Zinc Oxide | 2 | 2 | 2 | 2 | 2 | 2 |
| Wax | 2 | 2 | 2 | 2 | 2 | 2 |
| Anti-aging | 2 | 2 | 2 | 2 | 2 | 2 |
| agent 1 | | | | | | |
| Anti-aging | 1 | 1 | 1 | 1 | 1 | 1 |
| agent 2 | | | | | | |
| Vulcanization | 2 | 2 | 2 | 2 | 2 | 2 |
| accelerator 1 | | | | | | |
| Vulcanization | 2 | 2 | 2 | 2 | 2 | 2 |
| accelerator 2 | | | | | | |
| Sulfur | 2 | 2 | 2 | 2 | 2 | 2 |

(Physical properties (index))

| | | | | | | |
|---|---|---|---|---|---|---|
| Breaking | 100 | 126 | 98 | 118 | 109 | 106 |
| Strength | | | | | | |
| Tearing Force | 100 | 98 | 96 | 116 | 120 | 110 |

In Comparative Example 1, soybean oil was blended as a non-aroma oil in the rubber composition. In Examples 1 to 3, when dehydrated castor oil was blended as a non-aroma oil in the rubber composition, the breaking strength and tear force were remarkably improved in the vulcanized rubber. However, in the rubber composition of Comparative Example 2, in which the content of the dehydrated castor oil was less than 15 parts by mass when the total amount of the diene-based rubber was 100 parts by mass, the tear force deteriorated when the rubber was vulcanized rubber. Further, in the rubber composition of Comparative Example 3 in which the content of the dehydrated castor oil was more than 40 parts by mass, the breaking strength and the tearing force deteriorated when the rubber was vulcanized rubber.

What is claimed is:

1. A rubber composition comprising a diene-based rubber and a dehydrated castor oil, wherein the content of the dehydrated castor oil is 15 to 40 parts by mass when the total amount of the diene-based rubber is 100 parts by mass.

2. The rubber composition according to claim 1, further comprising silica.

3. A pneumatic tire comprising a vulcanized rubber of the rubber composition according to claim 1.
